(19) United States
(12) Patent Application Publication
(10) Pub. No.: US 2017/0298878 A1
(43) Pub. Date: Oct. 19, 2017

(54) FUEL TANK INLET CHECK VALVE REPLACEMENT KIT

(71) Applicant: Edlund Ellis, SR., South Bend, IN (US)

(72) Inventor: Edlund Ellis, SR., South Bend, IN (US)

(21) Appl. No.: 15/448,743

(22) Filed: Mar. 3, 2017

Related U.S. Application Data
(60) Provisional application No. 62/322,483, filed on Apr. 14, 2016.

(51) Int. Cl. F02M 37/00

(52) U.S. Cl. CPC F02M 37/0023

(57) ABSTRACT

A fuel tank inlet check valve replacement kit is provided. The fuel tank inlet check valve replacement kit is adapted to obviate the need to replace the entire fuel tank when there is a fracture in the inlet check valve. The replacement kit includes a fuel inlet fluidly connected to a body portion thereof. Within a chamber of the body portion a spring-biased check valve may be moveable between an open condition and a closed condition blocking the flow between the body portion and the fuel inlet, wherein fuel supplied through the fuel inlet moves the check valve to the open condition, that is otherwise biased in the closed condition. The chamber has side ports so that fuel flowing from the fuel inlet flows into the fuel tank. Tank seals and a gasket seals the fuel inlet to the tank.

### CROSS-REFERENCE TO RELATED APPLICATION

This application claims the benefit of priority of U.S. provisional application No. 62/322,483, filed 14 Apr. 2016, the contents of which are herein incorporated by reference.

### BACKGROUND OF THE INVENTION

The present invention relates to vehicle repair and, more particularly, a fuel tank inlet check valve replacement kit.

Most vehicular fuel tanks have an inlet check valve (ICV). Which is located above the full fuel level. A ICV fracture would cause a fuel leak during refueling as the fuel passes over the fracture. Such a fracture would also result in a fuel odor from the fuel vapors passing through the fracture, droplets of fuel accumulating on the outer side of the fuel tank, illumination of the vehicle's Service Engine Soon (SES), and poor gas mileage.

All of this would militate for the fracture to be fixed. Unfortunately, in the case of even a tiny fracture along an ICV, because current ICV units are typically made of plastic and rigidly connected to the fuel tank, the ICV itself cannot be replaced, but rather the entire fuel tank would need to be replaced. Such replacement can be an expensive proposition.

As can be seen, there is a need for a fuel tank inlet check valve replacement kit, obviating the need to replace the entire fuel tank when there is a fracture around the ICV, whereby merely replacing of the ICV itself would stop the escaping fuel vapors, while improving fuel consumption.

### SUMMARY OF THE INVENTION

In one aspect of the present invention, a fuel tank inlet check valve replacement kit includes a body portion providing a chamber; a fuel inlet fluidly connected to the chamber by way of a cavity; an overturn check valve disposed in the chamber, wherein the overturn check valve provides an engagement portion dimensioned and adapted to snugly conform to the cavity; a valve spring disposed in the chamber biasing the overturn check valve in a closed condition snugly conforming the engagement portion to the cavity blocking the fluid connection between the fuel inlet and the chamber; and at least one side port communicating with the chamber, whereby fluid pressure from the fuel inlet against the engagement portion moves the engagement portion to an open condition fluidly communicating the fuel inlet and the chamber.

In another aspect of the present invention, the fuel tank inlet check valve replacement kit further includes the following: an outer tank seal and an inner tank seal, wherein each tank seal slides over a distal end of the fuel inlet so as to engage a proximal end thereof; an inlet flange extending radially from the proximal end of the fuel inlet, wherein the inner tank seal sits on the inlet flange; a threading provided along an outer circumference of the fuel inlet adjacent to the inlet flange, wherein the threading is dimensioned and adapted to securely engage both tank seals; a gasket disposed along the threading and between the outer and inner tank seals; and a locking ring dimensioned and adapted to engage the threading in a locking engagement.

In yet another aspect of the present invention, a method of providing a replaceable fuel inlet for a fuel tank, includes the steps of: providing an inlet opening for the fuel tank; sliding the fuel tank inlet check valve replacement kit disclosed above so that the inner and outer tank seals abut an inward-facing and an outward-facing portion of a periphery of the inlet opening, respectively; and securing the locking ring in the locking engagement sandwiching the outer tank seal and the gasket against said outward-facing portion, whereby the distal end of the fuel inlet protrudes from the fuel tank.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention, rotated 180 degrees about a vertical axis relative to FIG. 1;

FIG. 3 is a section view of an exemplary embodiment of the present invention, as taken by line 3-3 in FIG. 1; and

FIG. 4 is a section view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fuel tank inlet check valve replacement kit that obviates the need to replace the entire fuel tank when there is a fracture in the inlet check valve. The replacement kit may include a fuel inlet fluidly connected to a body portion. Within a chamber of the body portion a spring-biased check valve may be moveable between an open condition and a closed condition blocking the flow between the body portion and the fuel inlet, wherein fuel supplied through the fuel inlet moves the check valve to the open condition, that is otherwise biased in the closed condition. The chamber has side ports so that fuel flowing from the fuel inlet flows into the fuel tank. Tank seals and a gasket seals the fuel inlet to the tank.

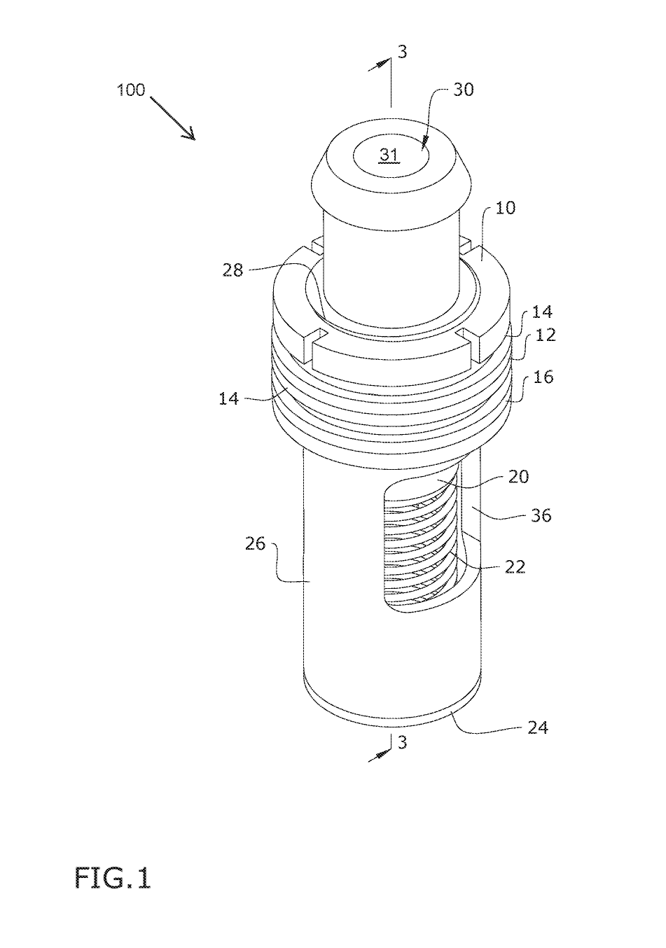

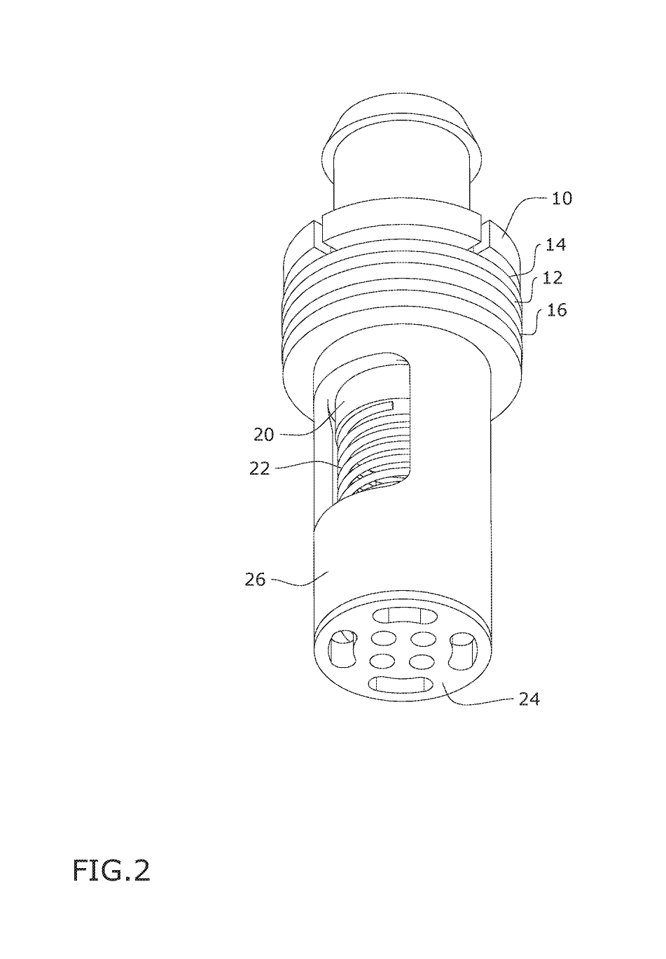

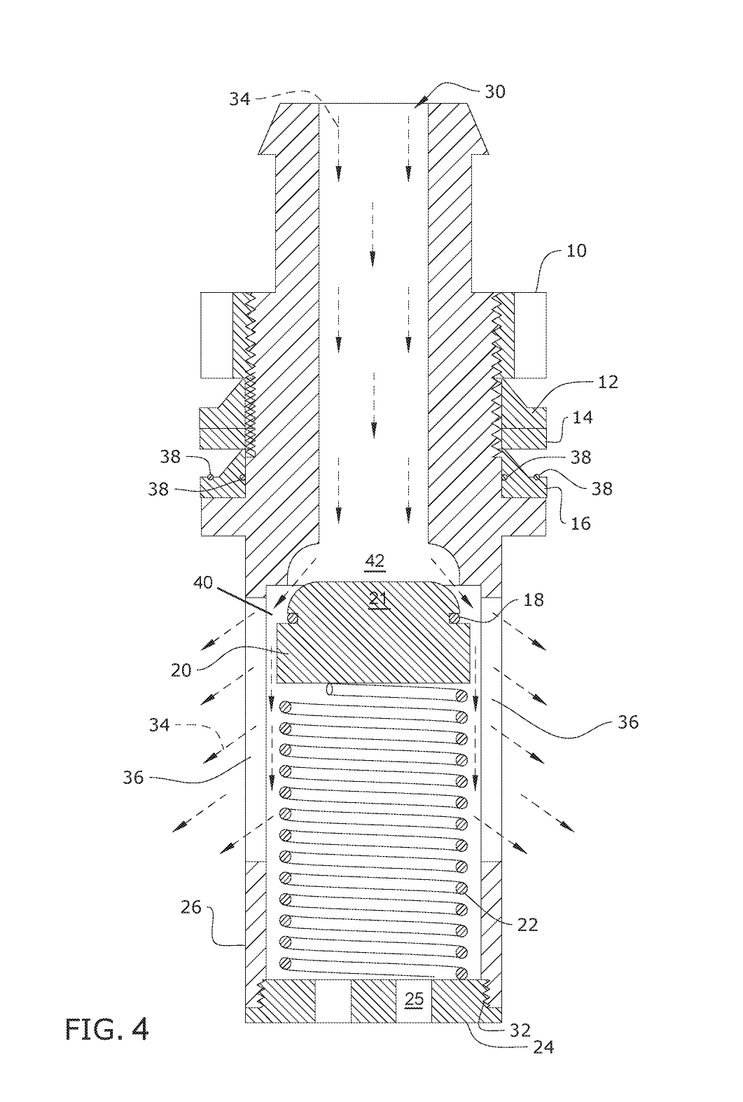

Referring now to FIGS. 1 through 4, the present invention may include the inlet check valve replacement kit 100. The inlet check valve replacement kit 100 may include a fuel inlet 30 fluidly stacked on a tubular body portion 26 so that the lumen 31 of the former fluidly communicates with a chamber 41 of the latter, as illustrated in FIG. 4. An inner periphery of said lumen 31 may increase as the lumen extends from a distal end to a proximal end to interface with the chamber 42, forming a cavity 42 at the proximal end of the lumen 31. Along an outer periphery of the fuel inlet 30, near its proximal end, threading 28 may be provided.

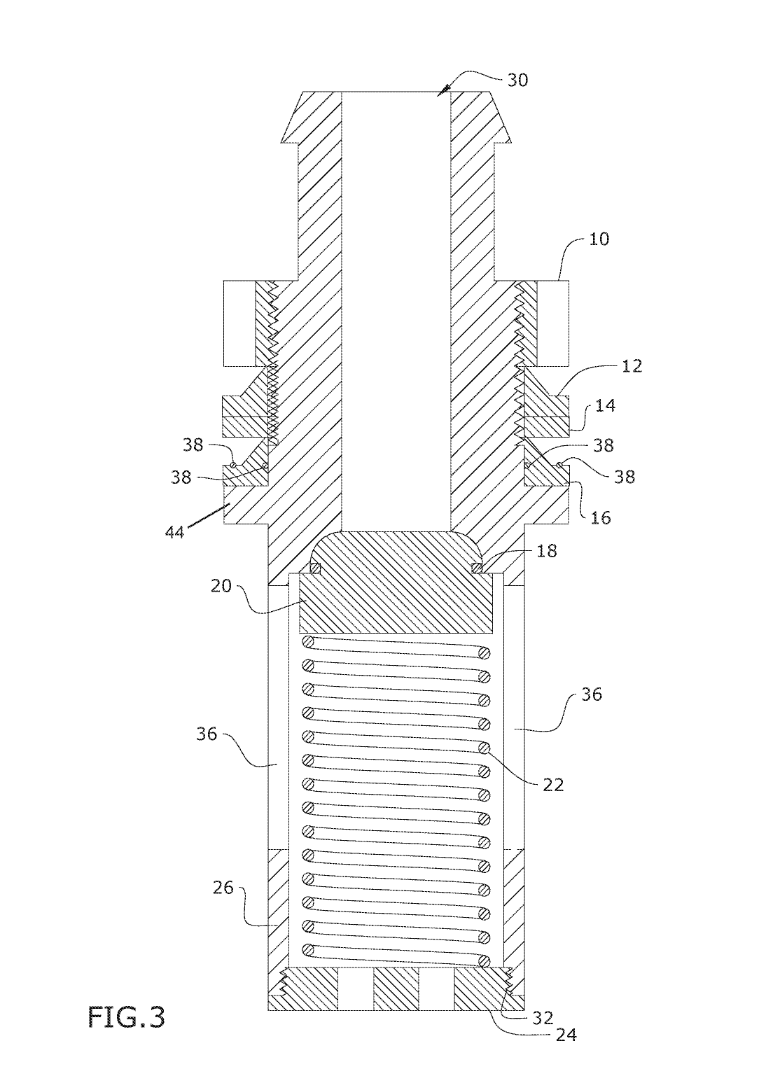

An inner tank seal 16 and an outer tank seal 12 may each provide an opening for sliding along the fuel inlet 30 so as to securely engage the threading 28 near the proximal end thereof on opposing sides of an associated fuel tank (not shown). Each seal 16 and 12 may have a tapering portion and a flange portion, as illustrated in FIG. 3. A gasket seal 14 may be disposed between the seals 16 and 12, so that the inner tank seal 16 seals the fuel inlet 30 to an inner portion of said fuel tank, while the outer tank seal 12 seals the fuel inlet 30 to the outer portion of the fuel tank, sandwiching the gasket seal 14 against said outer portion of the fuel tank. The inner tank seal 16 may sit on an inlet flange 44, as illustrated in FIGS. 3 and 4. Seal o-rings 38 and their receiving grooves may be provided along the inner tank seal 30 to facilitate the sealed condition. A locking ring 10 may securely mate over the threading 28, sitting on top of the outer tank seal 12.

The chamber 40 may extend from a proximal end facing the fuel inlet 30 to a distal end. Along an inner periphery, near the distal end, chamber threading 32 may be provided to securely mate a removable end drain cap 24. The end drain cap 24 may provide a plurality of holes 25. Within the chamber 40 an overturn check valve 20 may operatively engage a valve spring 22 interconnecting the check valve 20 and the end drain cap 24. The check valve 20 may have an engagement portion 21 dimensioned and adapted to snugly engage the cavity 42 in a closed condition. A valve o-ring 18 along a periphery of the engagement portion 21 may be adapted to provide a fluid seal in the closed condition. The valve spring 22 biases the engagement portion 21 in the closed condition but allows for the check valve 20 to move to an open condition upon sufficient urging.

Side ports 36 may be formed in the body portion 26 so that fluid in the chamber 40 may flow therethrough into the fuel tank.

Both the body portion 26 and the fuel inlet 30 may be made out of aluminum or other material that does not corrode when in contact with fuel 34.

A method of using the present invention may include the following. The inlet check valve replacement kit 100 disclosed above may be provided. A user may remove a fuel tank for its vehicle and then remove the fuel pump assembly including an old filler neck thereof from the fuel tank, so that the fuel tank has an open inlet hole. Then the user mounts the operatively engaged body portion 26 and the fuel inlet 30 through the fuel tank's inlet hole. A guide or pull wire may be used to facilitate. Positioning the fuel inlet 30 so that the gasket seal 14 and outer tank seal 16 are outside the fuel tank, the user may move the locking ring 10 in the locking engagement with the outer portion of the fuel tank. Then when the user supplies fuel 34 through the fuel inlet 26, the pressure of the fuel 34 urges the check valve 20 into the open condition, filling the chamber 40 with the fuel 34 that then flows through the side ports 26 into the fuel tank. When the re-fueling is complete, the lack of pressure causes the check valve via the spring 22 to move to the closed condition, as illustrated in FIG. 3. The outer gasket seal 14 prevents fuel 34 from leaking from the fuel tank, while the check valve 20 in the closed condition keeps the fuel 34 and vapor from escaping through the fuel inlet 30. If there is a fracture in the fuel inlet 30, then it can be easily replaced as opposed to replacing the entire fuel tank.

It should be understood, of course, that the foregoing relates to exemplary embodiments of the invention and that modifications may be made without departing from the spirit and scope of the invention as set forth in the following claims.

What is claimed is:

1. A fuel tank inlet check valve replacement kit, comprising:
a body portion providing a chamber;
a fuel inlet fluidly connected to the chamber by way of a cavity;
an overturn check valve disposed in the chamber, wherein the overturn check valve provides an engagement portion dimensioned and adapted to snugly conform to the cavity;
a valve spring disposed in the chamber biasing the overturn check valve in a closed condition snugly conforming the engagement portion to the cavity blocking the fluid connection between the fuel inlet and the chamber; and
at least one side port communicating with the chamber,
whereby fluid pressure from the fuel inlet against the engagement portion moves the engagement portion to an open condition fluidly communicating the fuel inlet and the chamber.

2. The fuel tank inlet check valve replacement kit of claim 1, further comprising:
an outer tank seal and an inner tank seal, wherein each tank seal slides over a distal end of the fuel inlet so as to engage a proximal end thereof.

3. The fuel tank inlet check valve replacement kit of claim 2, further comprising:
an inlet flange extending radially from the proximal end of the fuel inlet, wherein the inner tank seal sits on the inlet flange.

4. The fuel tank inlet check valve replacement kit of claim 3, further comprising:
a threading provided along an outer circumference of the fuel inlet adjacent to the inlet flange, wherein the threading is dimensioned and adapted to securely engage both tank seals.

5. The fuel tank inlet check valve replacement kit of claim 4, further comprising:
a gasket disposed along the threading and between the outer and inner tank seals.

6. The fuel tank inlet check valve replacement kit of claim 5, further comprising:
a locking ring dimensioned and adapted to engage the threading in a locking engagement.

7. A method of providing a replaceable fuel inlet for a fuel tank, comprising the steps of:
providing an inlet opening for the fuel tank;
sliding the fuel tank inlet check valve replacement kit of claim 6 so that the inner and outer tank seals abut an inward-facing and an outward-facing portion of a periphery of the inlet opening, respectively; and
securing the locking ring in the locking engagement sandwiching the outer tank seal and the gasket against said outward-facing portion,
whereby the distal end of the fuel inlet protrudes from the fuel tank.
